(19) United States
(12) Patent Application Publication
(10) Pub. No.: US 2004/0028269 A1
(43) Pub. Date: Feb. 12, 2004

(54) Photomask unit, photomask device, projection exposure device, projection exposure method and semiconductor device

(76) Inventors: Osamu Yamabe, Tokyo (JP); Junji Miyazaki, Hyogo (JP); Takashi Kozeki, Yamaguchi (JP); Shigeto Shigematsu, Yamaguchi (JP); Hiroaki Nakagawa, Yamaguchi (JP)

Correspondence Address: FOLEY AND LARDNER, SUITE 500, 3000 K STREET NW, WASHINGTON, DC, 20007, US

(21) Appl. No.: 10/239,657

(22) PCT Filed: Dec. 26, 2001
(86) PCT No.: PCT/JP01/11463

(30) Foreign Application Priority Data
Dec. 27, 2000 (JP) 2000-397871

(51) Int. Cl. G06K 9/00

(52) U.S. Cl. 382/144

(57) ABSTRACT

The atmosphere surrounding a photomask provided with a pellicle (2), particularly, an organic pellicle is replaced for purging with a mixed gas prepared by mixing an inert gas and a small amount of an active gas. The atmosphere in a space (8) between a mask base (1) and a pellicle (2) in a photomask is replaced for purging with a mixed gas prepared by mixing an inert gas and a small amount of an active gas.

### TECHNICAL FIELD

The present invention relates to an improved photomask structure, a projection exposure system and a projection exposure method employing the photomask, and a semiconductor device.

More concretely, the present invention relates to a photomask structure capable of solving problems caused in a pellicle by the use of exposure light of a short wavelength for circuit pattern transfer in fabricating semiconductor integrated circuits, and to the use of the same photomask structure.

### BACKGROUND ART

FIG. 8 shows a conception of a photolithographic exposure technique of transferring a pattern of a semiconductor integrated circuit to a wafer. A mask base 1 is provided with a pellicle 2. A photomask pattern 3 is formed on a surface, covered with the pellicle 2, of the mask base 1. The pellicle 2 prevents the adhesion of fine particles floating in the atmosphere to the photomask patter 3. Light emitted by an exposure light source 6 (concretely, an oscillating F2 laser) travels through the mask base 1, the pellicle 2 and a projection optical system 4 as indicated by the arrow in FIG. 8, and forms an image of a photomask on an exposed substrate 5 (concretely, a wafer).

Recently, the wavelength of exposure light has been progressively reduced with the miniaturization of design rules for semiconductor integrated circuit patterns. Most prevalently used light sources for exposure systems for transferring circuit pattern are KrF excimer lasers capable of emitting 248 nm wavelength of laser light. ArF excimer lasers capable of emitting 193 nm wavelength of laser light are second most prevalently used light sources, and vacuum ultraviolet F₂ lasers capable of emitting 157 nm wavelength of laser light follow excimer lasers. F₂ laser light is absorbed by oxygen and moisture contained in the atmosphere and hence purging with nitrogen is necessary. The F₂ laser generation needs avoiding the adhesion of fine particles to the mask base and hence the pellicle is indispensable.

FIG. 9 is a graph showing the relation between the exposure of light emitted by a F₂ excimer laser (horizontal axis) and the transmittance (vertical axis) of a pellicle in the conventional photomask as shown in FIG. 8. The scale of exposure dose measured on the horizontal axis is on the order of 10 kJ. The maximum of transmittance measured on the vertical axis is 100%. As obvious from FIG. 9, the pellicle formed of a polymer is readily destroyed when irradiated with a F₂ laser light emitted by the F₂ excimer laser because the energy of the F₂ laser light is very high and, consequently, the life of the pellicle is very short as compared with that of conventional pellicles. Since the pellicle has a very small thickness in the range of 600 to 1000 nm, the resistance of the pellicle against the high-energy laser light emitted by the F₂ laser is very low and hence the life of the pellicle is short. The short life is a critical problem with organic pellicles.

Research and development activities for the rapid development of pellicles for the F₂ generation, particularly organic pellicles, have been made. The small thickness and uniformity of organic pellicles are the most significant advantages of organic pellicles and are important requisites for the F₂ generation.

The present invention provides an improved photomask, and a projection exposure system and a projection exposure method using the same photomask to utilize the advantages of pellicles, particularly, organic pellicles, and to solve problems in the prior art.

### DISCLOSURE OF THE INVENTION

According to the present invention, a photomask device includes: a photomask unit including a photomask base, a pellicle extended opposite to a surface of the photomask base at a predetermined distance from the same surface, and a frame holding the pellicle and sealing a space between the photomask base and the pellicle; and a vessel accommodating the photomask unit, and having major walls disposed opposite to the photomask base or the pellicle respectively at predetermined distances from the photomask base or the pellicle and formed of a transparent material, wherein the vessel is filled up with an inert gas containing a predetermined quantity of an active gas.

The present invention improves the resistance of the pellicle against a short-wave exposure light, such as laser light emitted by a F₂ laser, and extends the life of the pellicle.

According to the present invention, a photomask device includes: a photomask unit including a photomask base, a pellicle extended opposite to a surface of the photomask base at a predetermined distance from the same surface, and a frame holding the pellicle and sealing a space between the photomask base and the pellicle; a vessel accommodating the photomask unit, and having major walls disposed opposite to the photomask base or the pellicle respectively at predetermined distances from the photomask base or the pellicle and formed of a transparent material; a gas supply means for supplying an inert gas containing a predetermined amount of an active gas into the vessel; and a gas recovering means for recovering gases discharged from the vessel.

With this configuration, even if outgases are produced in the vessel, those outgases can be removed and new gases can be supplied into the vessel. Thus, the resistance of the pellicle against a short-wave exposure light, such as laser light emitted by a F₂ laser, can be improved and the life of the pellicle can be extended.

According to the present invention, a photomask unit includes the photomask base, the pellicle extended opposite to a surface of the photomask base at a predetermined distance from the same surface, and the frame holding the pellicle and sealing a space between the photomask base and the pellicle. The space defined by the photomask base, the frame and the pellicle is filled up with an inert gas containing a predetermined quantity of an active gas.

Thus, the resistance of the pellicle against a short-wave exposure light, such as laser light emitted by a F₂ laser, can be improved and the life of the pellicle can be extended.

According to the present invention, a photomask unit includes the photomask base, the pellicle extended opposite to a surface of the photomask base at a predetermined distance from the same surface, and a frame holding the pellicle and sealing a space between the pellicle and the photomask base. The photomask unit according to the present invention is provided with a gas supply port through which gases are supplied from external gas sources into the space defined by the photomask base, the frame and the pellicle, and a gas discharge port through which gases are discharged outside from the space.

With this configuration, even if outgases are produced in the vessel, those outgases can be removed and new gases can be supplied into the vessel. Thus, the resistance of the pellicle against a short-wave exposure light, such as laser light emitted by a F₂ laser, can be improved and the life of the pellicle can be extended.

According to the present invention, a photomask unit includes a photomask base, a pellicle extended opposite to a surface of the photomask base at a predetermined distance from the same surface, and a frame holding the pellicle and sealing a space between the photomask base and the pellicle. According to the present invention, the photomask unit further includes a gas supply means for supplying an inert gas containing a predetermined amount of an active gas into the space, and a gas recovering means for recovering gases discharged from the space.

With this configuration, even if outgases are produced in the space, those outgases can be removed and new gases can be supplied into the space. Thus, the resistance of the pellicle against a short-wave exposure light, such as laser light emitted by a F₂ laser, can be improved and the life of the pellicle can be extended.

A projection exposure system according to the present invention includes: an exposure light source; the photomask device according to the present invention or the photomask unit according to the present invention; and an optical system for irradiating a surface of a workpiece with exposure light transmitted through the photomask device or the photomask unit.

Thus, the resistance of the pellicle against a short-wave exposure light, such as laser light emitted by a F₂ laser, can be improved and the life of the pellicle can be extended.

In the photomask device, the photomask unit and the projection exposure system according to the present invention, the pellicle may be an organic film.

The life of the pellicle can be extended.

In the photomask device, the photomask unit and the projection exposure system according to the present invention, the inert gas may be N₂ or any one of rare gases, such as Ar and He.

Thus, the resistance of the pellicle against a short-wave exposure light, such as laser light emitted by a F₂ laser, can be improved and the life of the pellicle can be extended.

In the photomask device, the photomask unit and the projection exposure system according to the present invention, the active gas may be any one of O₂, O₃, CO₂, CO, a nitrogen oxide (NOₓ), a sulfur oxide (SOₓ) and an organic gas containing oxygen.

Thus, the resistance of the pellicle against a short-wave exposure light, such as laser light emitted by a F₂ laser, can be improved and the life of the pellicle can be extended.

In the photomask device, the photomask unit and the projection exposure system according to the present invention, the concentration of the active gas may be in the range of 50 to 10,000 ppm.

Thus, the resistance of the pellicle against a short-wave exposure light, such as laser light emitted by a F₂ laser, can be improved and the life of the pellicle can be extended.

A semiconductor device according to the present invention is fabricated by using the projection exposure system according to the present invention.

Thus, the resistance of the pellicle against a short-wave exposure light, such as laser light emitted by a F₂ laser, can be improved and the life of the pellicle can be extended when the pellicle is used in a lithographic process of the next generation using an exposure system using a vacuum ultraviolet laser for transferring a photomask pattern to a workpiece. Thus, big cost reduction in fabricating processes can be expected.

### BRIEF DESCRIPTIONS OF THE DRAWINGS

FIG. 1 is a sectional view of a photomask employed in the first embodiment of the present invention;

FIG. 2 is a conceptional view of a projection exposure system in the first embodiment of the present invention;

FIG. 3 is a graph showing the variation of the transmittance of the pellicle with exposure dose in first third embodiment of the present invention;

FIG. 4 is a sectional view of a photomask device in the second embodiment of the present invention;

FIG. 5 is a graph showing the variation of the transmittance of the pellicle with exposure dose in the third embodiment of the present invention;

FIG. 6 is a sectional view of a photomask unit in the fourth embodiment of the present invention;

FIG. 7 is a sectional view of a photomask unit in the fifth embodiment of the present invention;

FIG. 8 shows a conception of a conventional photolithographic exposure technique of transferring a pattern;

FIG. 9 is a graph showing the conventional variation of the transmittance of the pellicle with exposure dose.

### BEST MODES FOR IMPLEMENTING THE INVENTION

In an exposure process using a projection exposure system using a photomask provided with a pellicle, particularly, an organic pellicle, the present invention purges an atmosphere around the photomask loaded into the projection exposure system or a space between a photomask base and the pellicle with an inert gas containing a predetermined quantity of an active gas to solve the foregoing problems in the prior art.

Thus, the resistance of the pellicle, particularly, the organic pellicle against a short-wave light, such as laser light emitted by a F₂ laser, can be improved and the life of the pellicle can be extended.

Preferred embodiments of the present invention will be described with reference to the accompanying drawings, in which like or corresponding parts are denoted by the same reference characters and duplicate description thereof will be omitted.

First Embodiment

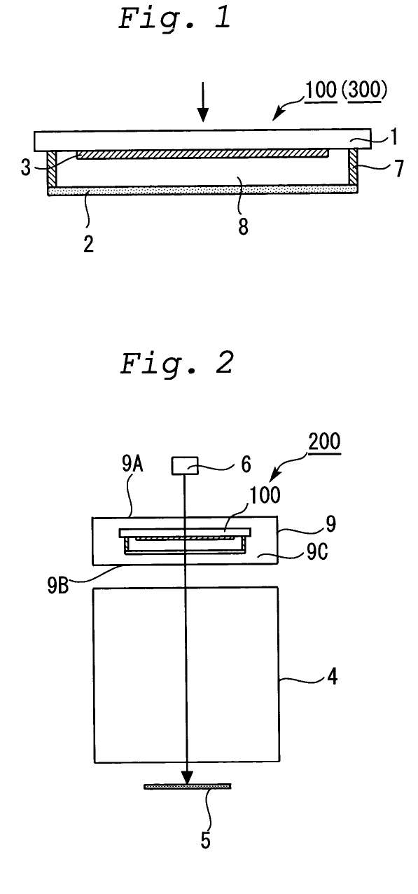

A first embodiment of the present invention will be described with reference to FIGS. 1 to 3.

FIG. 1 is a sectional view of a photomask employed in the first embodiment of the present invention, showing the relation between an organic pellicle and a mask base. FIG. 2 is a conceptional view of the photomask of this embodiment and a projection exposure system to which the photomask is applied.

Shown in FIG. 1 are a mask base 1, an organic pellicle 2, a photomask pattern 3, a frame (or a beam) 7, and a space 8 and gases 8 filled in the space 8. The photomask pattern 3 is formed on one surface of the mask base 1. The organic pellicle 2 is stretched on the frame 7 substantially parallel to the photomask pattern 3 at a predetermined distance from the photomask pattern 3 to protect the photomask pattern 3. The organic pellicle 2 and the frame 7 define the sealed space 8. The space 8 is filled up with an inert gas. The organic pellicle 2 is formed of a fluorocarbon polymer or the like. The frame 7 is formed of aluminum or the like. Those components constitute a photomask unit 100. The photomask unit 100 of the foregoing construction is generally known.

In the photomask unit 100 shown in FIG. 1, light emitted by an exposure light source, such as laser light emitted by a F₂ laser, travels through the mask base 1, photomask pattern 3, the space 8 and the organic pellicle 2. Generally, the thickness of the space 8 is about 6 mm.

Referring to FIG. 2, there are shown the photomask unit 100 shown in FIG. 1, a vessel 9 accommodating the photomask unit 100. The photomask unit 100 and the vessel 9 constitute a photomask device 200 in the first embodiment. In this specification, a combination of a pellicle and a photomask is referred to as a photomask unit, and a combination of a photomask unit and a vessel will be referred to as a photomask device.

The vessel 9 has walls 9A and 9B formed of a material capable of transmitting the exposure light, such as calcium fluoride (CaF₂) or magnesium fluoride (MgF₂). The photomask unit 100 is disposed and supported by a support structure, not shown, in the vessel 9 substantially parallel to the walls 9A and 9B at predetermined distances respectively from the walls 9A and 9B. A space 9C defined by the vessel 9 is filled up with an inert gas containing a predetermined amount of an active gas.

Shown in FIG. 2 are a projection optical system 4, a workpiece 5 and an exposure light source 6, which constitute a projection exposure system. The workpiece 5 is, for example, a semiconductor wafer, and the exposure light source 6 is, for example, a F₂ laser.

When loading the photomask device 200 into the projection exposure system, the interior space of the vessel 9 accommodating the photomask unit 100 is purged with an inert gas containing an active gas in a concentration in the range of 50 to 10,000 ppm.

In a projection exposure process, light emitted by the exposure light source 6 and guided by an optical system, not shown, travels through the transparent wall 9A of the photomask device 200, the photomask unit 100, and the wall 9B. The light is converged by the projection optical system 4 and the converged light is projected on a surface of the workpiece 5 to expose a film formed on the same surface of the workpiece 5.

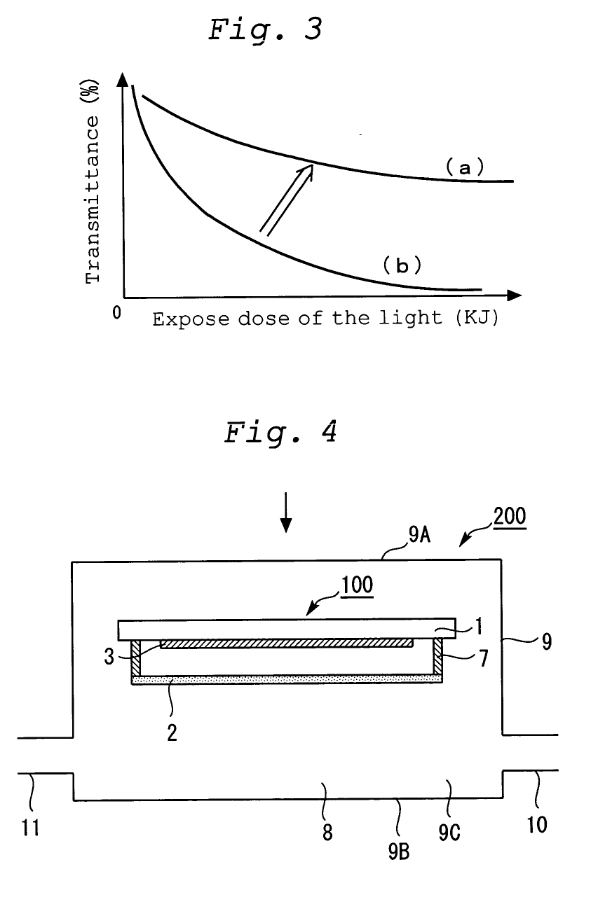

The life of the organic pellicle of the photomask unit 100 can be extended by using the photomask device 200. FIG. 3 shows this effect. In FIG. 3, the transmittance (%) of the pellicle is measured on the vertical axis, and the exposure dose (kJ) of the light emitted by the F₂ laser on the pellicle is measured on the horizontal axis. The maximum value on the vertical axis is 100%, and the maximum value on the horizontal axis is on the order of 10 kJ. In FIG. 3, a curve (a) indicates the variation of the transmittance of the pellicle with exposure dose when the interior space 9C of the photomask device 200 shown in FIG. 2 is filled with an inert gas containing an active gas in about 1000 ppm.

It is known from FIG. 3 that the transmittance of the pellicle in the conventional photomask device decreases greatly as the exposure dose increases as indicated by the curve (b), whereas the transmittance of the pellicle in the photomask device 200 in which the interior space 9C is purged with the inert gas containing the active gas in about 1000 ppm does not decrease sharply as indicated by the curve (a). Thus, the life of the pellicle is extended.

Although N₂ or a rare gas, such as Ar or He, is suitable as the inert gas, the inert gas does not need to be limited thereto and any inert gas transparent to the exposure light may be used. The active gas to be mixed in the inert gas is any one of O₂, O₃, CO₂, CO, a nitrogen oxide (NOₓ), a sulfur oxide (SOₓ) or an organic gas containing oxygen, such as an alcohol, an ether, a ketone, an aldehyde or such, but is not necessarily limited thereto.

A suitable concentration of the active gas is in the range of 50 to 10,000 ppm. Although higher the active gas concentration, the longer is the life of the pellicle, the quantity of transmitted light has tendency to decreases as the active gas concentration increases. A proper active gas concentration can be selectively determined as the occasion demands. The foregoing range of the active gas concentration is preferable to achieve both the extension of the life of the pellicle and the transmission of light at a high transmittance.

The conditions for the active gas and the inert gas apply to the following embodiments, and hence the further description thereof will be omitted to avoid duplication.

Although the embodiment employing the organic pellicle has been described, the present invention may employ any suitable pellicle other than the organic pellicle.

Second Embodiment

A second embodiment according to the present invention will be described with reference to FIG. 4. FIG. 4 is a sectional view of a photomask device 200 in the second embodiment of the present invention.

Shown in FIG. 4 are a vessel 9, a gas supply port 10 formed in a side wall of the vessel 9, and a gas discharge port 11 formed in another side wall of the vessel 9. The photomask device 200 is the same in other respects as that shown in FIG. 2 and hence the further description thereof will be omitted.

After the photomask device 200 in the second embodiment has been loaded into a projection exposure system, an inert gas containing an active gas in a predetermined concentration is supplied through the gas supply port 10 into the vessel 9 and the inert gas is discharged through the discharge port 11 to purge the interior of the vessel 9. The discharged inert gas is recovered or dissipated.

A gas supply means, not shown, may supply the gases from external gas sources through pipes or may use like as gas cylinders connected to the vessel 9 as gas sources.

Even if outgases are produced in the vessel 9 during projection exposure, those outgases can be discharged from the vessel 9 and the new mixed gas can be supplied into the vessel 9 to prevent the reduction of transmittance.

Third Embodiment

A photomask unit in a third embodiment according to the present invention is similar in construction to that shown in FIG. 1.

The atmosphere of the space 8 shown in FIG. 1, i.e., the space 8 between the mask base 1 and the pellicle 2, is replaced with a mixed gas of an inert gas and a predetermined quantity of an active gas for purging, and then the space 8 is filled up with the mixed gas to obtain a photomask unit 300.

In the projection exposure system shown in FIG. 2, the photomask device 200 is replaced with the photomask unit 300. The projection exposure system performs the same projection exposure operation as that previously described in connection with FIG. 2.

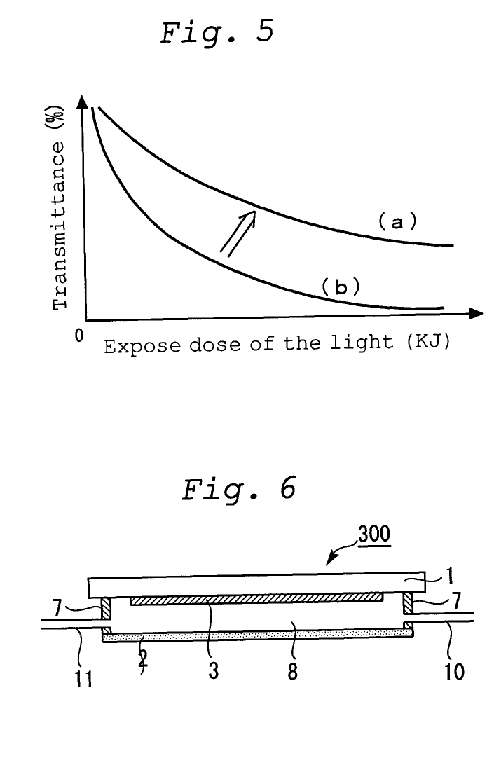

The use of the photomask unit 300 extends the life of the pellicle. The effect of the photomask unit 300 on the extension of the pellicle is shown in FIG. 5. In FIG. 5, the transmittance (%) of the pellicle is measured on the vertical axis, and the exposure dose (kJ) of the light emitted by the F₂ laser on the pellicle is measured on the horizontal axis. The units and scales in FIG. 5 are the same as those in FIG. 3. In FIG. 5, a curve (a) indicates the variation of the transmittance of the pellicle with exposure dose when the space 8 of the photomask unit 300 shown in FIG. 1 is filled with an inert gas containing an active gas in about 1000 ppm.

It is known from FIG. 5 that the transmittance of the pellicle in the conventional photomask unit decreases greatly as the exposure dose increases as indicated by the curve (b), whereas the transmittance of the pellicle in the photomask unit 300 in which the space 8 is purged with the inert gas containing the active gas in about 1000 ppm does not decrease sharply as indicated by the curve (a). Thus, it is known that the life of the pellicle is extended (curve (a)).

It is known from FIGS. 3 and 5 that the first embodiment, in which the atmosphere of the space surrounding the photomask unit is replaced with the mixed gas of the inert gas and the active gas for purging, is more effective in transmission improvement than the third embodiment, in which the atmosphere of the space sealed by the pellicle and the photomask is replaced with the mixed gas of the inert gas and the active gas for purging.

Fourth Embodiment

A fourth embodiment according to the present invention will be described with reference to FIG. 6, which is a sectional view of a photomask unit 300 in the fourth embodiment. The photomask unit 300 has a frame 7 provided with a gas supply port 10 in one side thereof, and a gas discharge port 11 in the other side thereof. The photomask unit 300 is the same in other respects as the photomask unit shown in FIG. 1 and hence the further description thereof will be omitted.

The photomask unit 300 is provided with the gas supply port 10 through which a purging gas prepared by mixing an inert gas and an active gas is supplied into a sealed space 8 between a photomask base 1 and a pellicle 3 for purging from an external gas supply system, not shown, and the gas discharge port 11 through which the gases are discharged to an external gas recovering system, not shown.

Thus, even if outgases are produced in the sealed space 8 during projection exposure, those outgases can be discharged from the sealed space 8 and the new purging gas can be supplied into the sealed space 8 to prevent the reduction of transmittance.

Fifth Embodiment

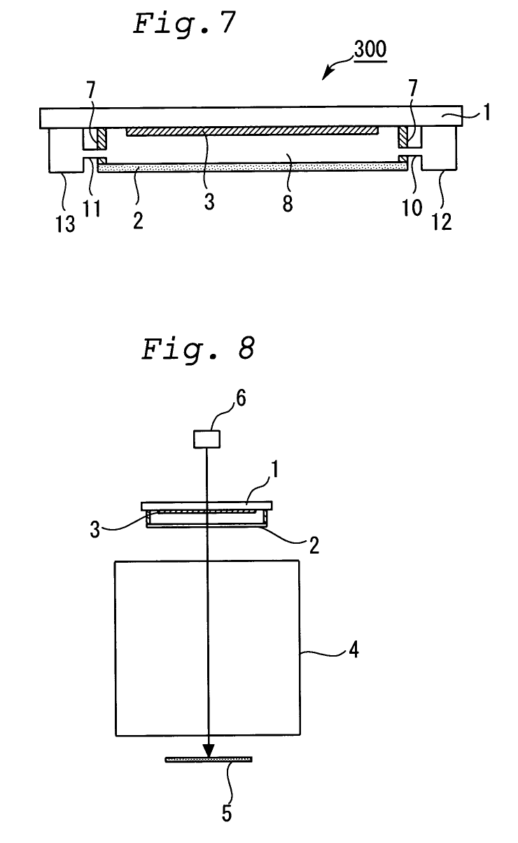

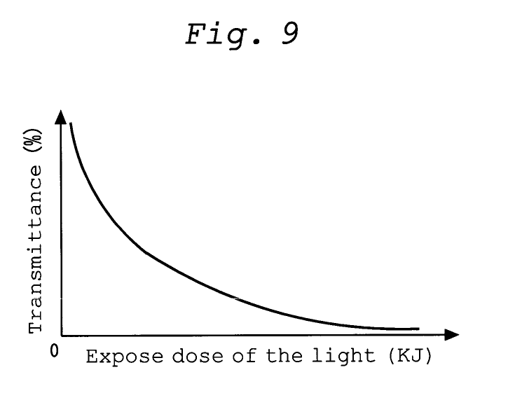

A fifth embodiment according to the present invention will be described with reference to FIG. 7, which is a sectional view of a photomask unit 300 in the fifth embodiment of the present invention.

In the photomask unit 300 shown in FIG. 7, a purging gas supply system (gas generating system) 12 and a purging gas recovering system 13 are combined with a photomask base 1. Both the purging gas supply system 12 and the purging gas recovering system 13 are of a photomask-appurtenant type. The photomask unit 300 is the same in other respects as that shown in FIG. 6 and hence the further description thereof will be omitted.

In the photomask unit 300, a purging gas prepared by mixing an inert gas and an active gas is supplied through a gas supply port 10 into a sealed space 8 between a photomask base 1 and a pellicle 3 for purging from the gas supply system 12, and the purging gas discharged through a gas discharge port 11 is recovered by the gas recovering system 13.

The gas recovering system 13 may be omitted and the photomask unit 300 may be provided with only the gas discharge port 11.

Industrial Applicability

As apparent from the foregoing description, the present invention solves problems attributable to the progressive shortening of the life of the pellicle resulting from the use of exposure light having shorter wavelength for circuit pattern transfer. That is, the present invention improves the resistance of a pellicle, particularly, an organic pellicle to exposure light having a short wavelength, such as laser light emitted by a F₂ laser, and extends the life of a pellicle when the pellicle is used in a lithographic process of the next generation using a photomask pattern transfer exposure system provided with a laser that emits laser light in the vacuum ultraviolet region. Thus, big cost reduction in fabricating processes can be expected.

1. A photomask device comprising:
a photomask unit including: a photomask base, a pellicle extended opposite to a surface of the photomask base at a predetermined distance from the same surface, and a frame holding the pellicle and sealing a space between the photomask base and the pellicle; and
a vessel accommodating the photomask unit, and having major walls disposed opposite to the photomask base or the pellicle at predetermined distances from the photomask base or the pellicle, and formed of a transparent material;
wherein the vessel is filled up with an inert gas containing a predetermined quantity of an active gas.

2. A photomask device comprising:
a photomask unit including: a photomask base, a pellicle extended opposite to a surface of the photomask base at a predetermined distance from the same surface, and a frame holding the pellicle and sealing a space between the photomask base and the pellicle;
a vessel accommodating the photomask unit, and having major walls disposed opposite to the photomask base or the pellicle at predetermined distances from the photomask base or the pellicle, and formed of a transparent material;
a gas supply means for supplying an inert gas containing a predetermined amount of an active gas into the vessel; and
a gas recovering means for recovering gases discharged from the vessel.

3. The photomask device according to claim 2, wherein
the gas supply means includes a gas supply port through which gases are supplied into the vessel, and
the gas recovering means includes a gas discharge port through which gases are discharge outside from the interior of the vessel.

4. The photomask device according to any one of claims 1 to 3, wherein the pellicle is an organic film.

5. The photomask device according to any one of claims 1 to 4, wherein the inert gas is N₂ or a rare gas, such as Ar or He.

6. The photomask device according to any one of claims 1 to 5, wherein the active gas is O₂, O₃, CO₂, CO, a nitrogen oxide (NOₓ), a sulfur oxide (SOₓ) or an organic gas containing oxygen.

7. The photomask device according to any one of claims 1 to 6, wherein the concentration of the active gas is in the range of 50 to 10,000 ppm.

8. A photomask unit comprising:
a photomask base;
a pellicle extended opposite to a surface of the photomask base at a predetermined distance from the same surface; and
a frame holding the pellicle and sealing a space between the pellicle and the photomask base;
wherein a space defined by the photomask base, the frame and the pellicle is filled up with an inert gas containing a predetermined quantity of an active gas.

9. A photomask unit comprising:
a photomask base;
a pellicle extended opposite to a surface of the photomask base at a predetermined distance from the same surface;
a frame holding the pellicle and sealing a space between the pellicle and the photomask base;
a gas supply port through which gases are supplied from external gas sources into the space defined by the photomask base, the frame and the pellicle; and
a gas discharge port through which gases are discharged outside from the space for recovery.

10. A photomask unit comprising:
a photomask base;
a pellicle extended opposite to a surface of the photomask base at a predetermined distance from the same surface;
a frame holding the pellicle and sealing a space between the photomask base and the pellicle;
a gas supply means for supplying an inert gas containing a predetermined amount of an active gas into the space; and
a gas recovering means for recovering gases discharged from the space.

11. The photomask unit according to any one of claims 8 to 10, wherein the pellicle is an organic film.

12. The photomask unit according to any one of claims 8 to 11, wherein the inert gas is N₂ or a rare gas, such as Ar or He.

13. The photomask unit according to any one of claims 8 to 12, wherein the active gas is O₂, O₃, CO₂, CO, a nitrogen oxide (NOₓ), a sulfur oxide (SOₓ) or an organic gas containing oxygen.

14. The photomask unit according to any one of claims 8 to 13, wherein the concentration of the active gas is in the range of 50 to 10,000 ppm.

15. The photomask device according to any one of claims 1 to 7, wherein the photomask unit is any one of the photomask units stated in claims 8 to 14.

16. A projection exposure system comprising:
an exposure light source;
the photomask device stated in any one of claims 1 to 7 and 15 or the photomask unit stated in any one of claims 8 to 14; and
an optical system for irradiating a surface of a workpiece with exposure light transmitted through the photomask device or the photomask unit.

17. A semiconductor device fabricated by using the projection exposure system stated in claim 16.
